(19) United States
(12) Patent Application Publication
(10) Pub. No.: US 2024/0080849 A1
(43) Pub. Date: Mar. 7, 2024

(54) Resource Allocation for Transport Block Transmission Over Multiple Slots

(71) Applicant: Apple Inc., Cupertino, CA (US)

(72) Inventors: Chunhai YAO, Beijing (CN); Chunxuan YE, San Diego, CA (US); Dawei ZHANG, Saratoga, CA (US); Hong HE, San Jose, CA (US); Huaning NIU, San Jose, CA (US); Haitong SUN, Saratoga, CA (US); Oghenekome OTERI, San Diego, CA (US); Seyed Ali Akbar FAKOORIAN, San Diego, CA (US); Sigen YE, San Diego, CA (US); Weidong YANG, San Diego, CA (US); Wei ZENG, Saratoga, CA (US); Yushu ZHANG, Beijing (CN)

(21) Appl. No.: 18/261,305

(22) PCT Filed: May 27, 2021
(86) PCT No.: PCT/CN2021/096216

§ 371 Date: Jul. 13, 2023

(30) Foreign Application Priority Data
Jan. 15, 2021 (WO) PCT/CN2021/072162

(51) Int. Cl. H04W 72/23; H04W 72/0446; H04W 72/21

(52) U.S. Cl. CPC H04W 72/23; H04W 72/0446; H04W 72/21

(57) ABSTRACT

Example embodiments of the present disclosure relate to methods, devices, apparatuses and computer readable storage media of resource allocation for transport block (TB) transmission over multiple slots. In example embodiments, a user device receives, from a network device, an indication of at least a number of slots associated with transmission of a TB, then transmits the TB to the network device over a plurality of valid slots selected based on the indication.

### FIELD

Embodiments of the present disclosure generally relate to the field of communication, and in particular, to methods, devices, apparatuses and computer readable storage media of resource allocation for transport block (TB) transmission over multiple slots.

### BACKGROUND

New Radio (NR) coverage enhancement has been approved in the fifth generation (5G). Some of the objectives are proposed for NR coverage enhancement. For example, the performance target for coverage enhancement is identified, and the potential solutions for coverage enhancements are studied. The target channels include at least Physical Uplink Shared Channel (PUSCH) and Physical Uplink Control Channel (PUSCH). Enhanced solutions may include time domain and frequency domain enhancement, Demodulation-Reference Signal (DM-RS) enhancement (including DM-RS-less transmission). The additional enhanced solutions may also be developed for Frequency Range 2 (FR2) if any. The performance of the potential solutions may be evaluated based on link level simulation.

Some agreements for NR coverage enhancement are proposed to be specified in the 3GPP standards such as 3GPP TR 38.830. For example, Transport Block (TB) processing over multi-slot PUSCH can be used for transmission/reception (TR). TB processing over multi-slot may have impacts on PUSCH in the terms of Time-Domain Resource Allocation (TDRA), Transport Block Size (TBS) determination, and Redundancy Version (RV) determination. Power consistency, phase continuity and enhancements for DM-RS configuration may or may not be required depending on factors such as cross-slot channel estimation.

### SUMMARY

In general, example embodiments of the present disclosure provide methods, devices, apparatuses and computer readable medium of resource allocation for TB transmission over multiple slots.

In a first aspect, a method is provided at a user device. In the method, the user device receives, from a network device, an indication of at least a number of slots associated with transmission of a transport block (TB). Then, the user device transmits the TB to the network device over a plurality of valid slots selected based on the indication of at least the number of slots.

In a second aspect, a method is provided at a network device. In the method, the network device determines a number of slots associated with transmission of a transport block (TB). The network device transmits, to a user device, the indication of at least the number of slots associated with transmission of the TB.

In a third aspect, a user device is provided which comprises: at least one processor; and at least one memory including computer program code; the at least one memory and the computer program code configured to, with the at least one processor, cause the user device to: receiving, at a user device and from a network device, an indication of at least a number of slots associated with transmission of a transport block, TB; and transmitting the TB to the network device over a plurality of valid slots selected based on the indication of at least the number of slots.

In a fourth aspect, a network device is provided which comprises: at least one processor; and at least one memory including computer program code; the at least one memory and the computer program code configured to, with the at least one processor, cause the network device to: determining, at a network device, a number of slots associated with transmission of a transport block, TB; and transmitting, at the network device and to a user device, the indication of at least the number of slots associated with transmission of the TB.

In a fifth aspect, an apparatus is provided which comprises means for performing the method according to the first or second aspect.

In a sixth aspect, a computer readable storage medium comprising program instructions stored thereon is provided, the instructions, when executed by a processor of a device, causing the device to perform the method of the first or second aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which example embodiments of the present disclosure can be implemented;

FIG. 2 illustrates a signaling flow between the network device and the user device according to some example embodiments of the present disclosure;

FIG. 3 shows a MAC CE configuration according to some embodiments of the present disclosure;

FIG. 4 shows an example MAC CE format according to some embodiments of the present disclosure;

FIG. 5a shows an Uplink-Downlink (UL-DL) configuration indicated by System Information Block (SIB)-1 UL-DL configuration according to some embodiments of the present disclosure;

FIG. 5b shows a UL-DL configuration indicated by SIB-1 UL-DL configuration and UE dedicated signaling according some embodiments of the present disclosure

FIG. 6 shows an example MAC CE configuration for the resource patterns according to some embodiments of the present disclosure;

FIG. 7 shows a flowchart of an example method of a user equipment (UE) transmitting transport blocks (TB) to a network device according to some example embodiments of the present disclosure;

FIG. 8 shows a flowchart of an example method of a network device configuring a number of slots for a TB transmission according to some example embodiments of the present disclosure; and

FIG. 9 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “user device” or “user equipment” (UE) refers to any user device capable of wireless communications with each other or with the base station. The communications may involve transmitting and/or receiving wireless signals using electromagnetic signals, radio waves, infrared signals, and/or other types of signals suitable for conveying information over the air. In some example embodiments, the UE may be configured to transmit and/or receive information without direct human interaction. For example, the UE may transmit information to the base station on predetermined schedules, when triggered by an internal or external event, or in response to requests from the network side.

Examples of the UE include, but are not limited to, smart phones, wireless-enabled tablet computers, laptop-embedded equipment (LEE), laptop-mounted equipment (LME), wireless customer-premises equipment (CPE), sensors, metering devices, personal wearables such as watches, and/or vehicles that are capable of communication. For the purpose of discussion, some example embodiments will be described with reference to UEs as examples of the user devices, and the terms “user device” and “user equipment” (UE) may be used interchangeably in the context of the present disclosure.

As used herein, the term “network device” refers to a device via which services can be provided to a user device in a communication network. As an example, the network device may comprise a base station. As used herein, the term “base station” (BS) refers to a network device via which services can be provided to a user device in a communication network. The base station may comprise any suitable device via which a user device or UE can access the communication network. Examples of the base stations include a relay, an access point (AP), a transmission point (TRP), a node B (NodeB or NB), an evolved NodeB (eNodeB or eNB), a New Radio (NR) NodeB (gNB), a Remote Radio Module (RRU), a radio header (RH), a remote radio head (RRH), a low power node such as a femto, a pico, and the like.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Conventionally, a TB is transmitted on physical resource blocks (PRBs) in a single slot, or the same TB is repeatedly transmitted in each slot of consecutive slots. The TB transmission on PRBs in a single slot may result in a lower Energy Per Resource Element (EPRE). The repeated TB transmission on each slot of consecutive slots may result in lower coding rate and more Cyclic Redundancy Check (CRC) padding.

In order to improve the performance of TB transmission, it is proposed to transmit one TB over more than one slot. For example, TB processing over multi-slot PUSCH is proposed for use in NR coverage enhancement. Currently, a key objective for TB processing over multi-slot PUSCH is to design one or more mechanisms to enable TB processing over multi-slot PUSCH, TBS determination based on multiple slots and TB transmission over multiple slots.

Example embodiments of the present disclosure provide a mechanism for TB transmission over a plurality of slots. A network device (such as a gNB or a base station) determines the number of slots associated with TB transmission. The number of slots may be the number of valid slots for TB transmission or the number of consecutive slots some of which can be used for TB transmission. The network device transmits an indication of the number of slots to a user device such as user equipment (UE). The indication may be used to indicate other configurations than the number of slots for TB transmission. For example, in some example embodiments, the indication may be used to indicate the number of slots and relative offset between the valid slots. Accordingly, upon reception of the indication of at least the number of slots, the user device determines a plurality of valid slots for TB transmission and transmits a TB over these valid slots.

In this way, the network device may allocate and indicate to the user device slot resources for TB transmission effectively and efficiently. At the user device, a plurality of valid slots for the TB transmission may be determined and then TB transmission may be performed over these valid slots, thereby improving the efficiency of TB transmission over multiple slots.

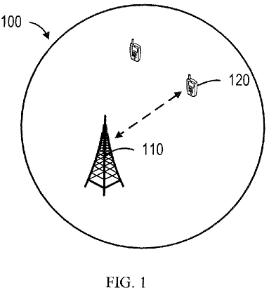

FIG. 1 shows an example environment 100 in which example embodiments of the present disclosure can be implemented.

The environment 100, which may be a part of a communication network, comprises a network device 110 and a user devices 120 communicating with each other.

It is to be understood that two devices are shown in the environment 100 only for the purpose of illustration, without suggesting any limitation to the scope of the present disclosure. In some example embodiments, the environment 100 may comprise a further device to communicate information with the network device 110 and user device 120.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

In various embodiments of the present disclosure, the network device 110 can determine the number of slots associated with TB transmission of the user device 120 and transmit an indication of at least the number of slots to the user device 120. Accordingly, the user device 120 can determine a plurality of valid slots based on the indication and transmit a TB to the network device 110 over these valid slots.

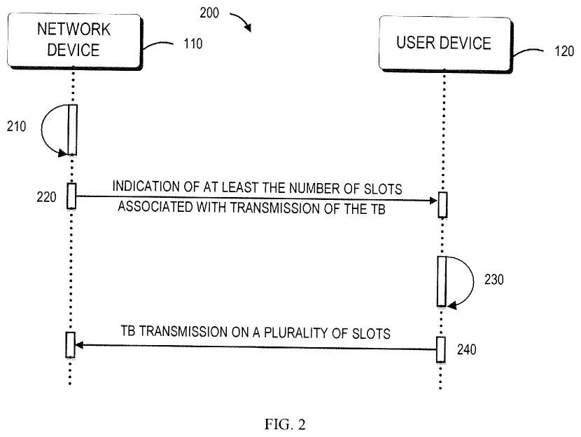

FIG. 2 shows a signaling flow 200 between the network device 110 and the user device 120 according to some example embodiments of the present disclosure. For the purpose of discussion, the signaling flow will be described with reference to FIG. 1.

As shown in FIG. 2, the network device 110 determines (210) a number of slots associated with transmission of a TB. The number of slots may be a number of consecutive slots some of which are valid or available for TB transmission. Alternatively or in addition, the number of slots may be a number of valid slots for transmission of the TB. In some embodiments, all of uplink slots may be configured or predefined to be valid for TB transmission. In some other embodiments, some of uplink slots may be scheduled or configured for TB transmission. For example, only UL slots indicated by system information block 1 (STB-1) UL-DL configuration (such as tdd-UL-DL-ConfigurationCommon) may be determined as valid slots for transmission of the TB.

Generally, the flexible slot transmission direction can be configured by UE dedicated signaling (such as tdd-UL-DL-ConfigurationDedicated). Accordingly, in some embodiments, a flexible slot may also be indicated as a valid slot for transmission of the TB. In some embodiments, the network device 110 may send an indication of a valid flexible slot configuration to the user device 120 to inform that certain flexible slots are configured to be valid for multi-slot TB transmission. This indication may be sent in UE dedicated signaling. For example, an indication of a flexible slot transmission direction sent by Slot Format Indication (SFI) (i.e., DCI format 2_0) may be used to indicate that the corresponding flexible slot is valid for TB transmission.

Then, the network device 110 transmits (220) to the user device 120 an indication of at least the number of slots associated with transmission of a TB. In addition to the number of slots, the indication may indicate other configurations for multi-slot TB transmission.

In some embodiments, the indication may be a semi-static indication via Radio Resource Control (RRC) signaling, such as a new RRC parameter “TotalSlotforTB”. In some embodiments, the indication may be a dynamic indication via Uplink grant in Downlink Control Information (such as UL DCI). For example, a new field “totalslotforTB” may be defined in UL DCI which indicates the number of slots associated with transmission of the TB. Alternatively or in addition, an existing field in UL DCI may be re-interpreted or reused if one or more spare bits of the existing field are available (depending on the specific design).

In some embodiments, a new field “totalSlotforTB” may be introduced in a TDRA table that is configured by RRC signaling. The value of the field “totalSlotforTB” may be indicated to the user device 120 via UL DCI. An example extended TDRA table is illustrated as below.

PUSCH-TimeDomainResourceAllocationList : := SEQUENCE (SIZE(1.. maxNrofUL-Allocations))
OF PUSCH-TimeDomainResourceAllocation
PUSCH-TimeDomainResourceAllocation : := SEQUENCE (
K2 INTEGER (0. . 32) OPTIONAL, --Need S
mappingType ENUMERATED {typeA, typeB},
startSymbolAndLength Integer (0 . .127)
totalSlotforTB ENUMERATED {n1, n2, n3, n4, n7, n8, n12, n16, n32} OPTIONAL

In this example, the TDRA table contains a new entry to indicate the configurations of the parameter “totalSlotforTB”. The configuration of the TDRA table can be adjusted via RRC signaling.

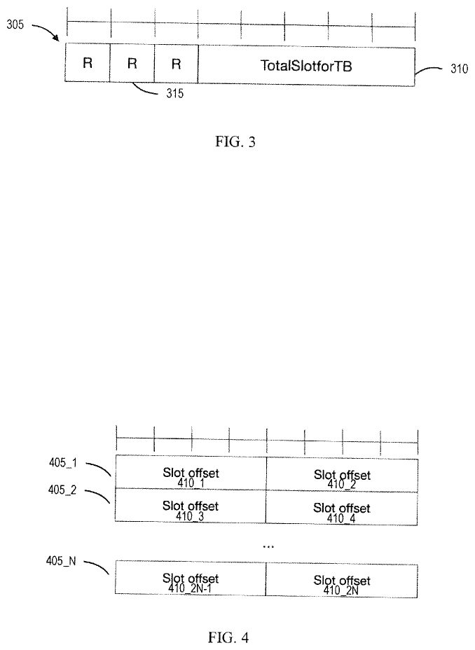

Alternatively or in addition, the indication may be a dynamic indication via a media access control (MAC) control element (CE). FIG. 3 shows a MAC CE configuration according to some embodiments of the present disclosure. As shown in FIG. 3, a MAC CE 305 contains the parameter “TotalSlotforTB” 310, and R 315 represents reserved bits.

In some embodiments, the indication via a MAC CE may indicate a relative offset between the valid slots. An example MAC CE format for such an indication will be discussed below with reference to FIG. 4.

FIG. 4 shows an example MAC CE format according to some embodiments of the present disclosure.

As shown in the FIG. 4, MAC CEs 405_1, 405_2 . . . 405_N (where N represents any suitable positive integer) are used to indicate a relative offset between adjacent valid slots. In this example, each MAC CE 405_1, 405_2 . . . 405_N (for example, 8 bits or one byte) is be divided into two elements 410_1, 410_2, 410_3, 410_4, . . . 410_2N−1, 410_2N (each consists of 4 bits). Each element indicates a relative offset between two adjacent valid slots. For example, the element 410_1 indicates a relative offset between the first valid slot (that is, a starting valid slot) and the second valid slot, the element 4102 indicates a relative offset between the second valid slot and the third valid slot, and so on. It may also be possible that each element indicates relative offset between a certain valid slot and the first valid slot. The location of starting valid slot may be indicated by k2 field in the TDRA table as shown above or indicated by the MAC CE itself as shown in FIG. 3.

For a MAC CE of 8 bits, each element includes 4 bits that can indicate 2 4=16 slot offsets. That is, the maximum offset between the first valid slot and the last valid slot is 16 slots. Meanwhile, the number of MAC CEs can indicate the number of slots. For example, because each MAC CE is divided into two elements, N MAC CE bytes may indicate 2N slots used to transmission of the TB. It is to be understood that the offset between the valid slots can be indicated by any other messages or signaling.

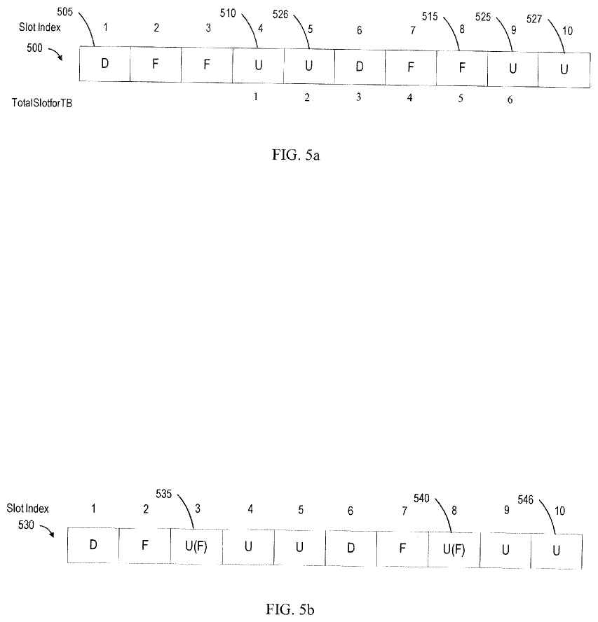

Still with reference to FIG. 2, after receiving the indication of at least the number of slots for TB transmission, the user device 120 determines (230) a plurality of valid slots based on the indication for TB transmission. In the embodiments where the number of slots represents the number of consecutive slots some of which are valid, the user device 120 may first determine a set of slots with the number of slots and then selects valid slots from the set of slots. An example process will discussed below with reference to FIG. 5a.

FIG. 5a shows an Uplink-Downlink (UL-DL) configuration 500 indicated by System Information Block (SIB)-1 UL-DL configuration according to some embodiments of the present disclosure.

As shown in FIG. 5a, a UL-DL configuration 500 is “DDSUU”, where “D” 505 represents a DL slot, “U” 510 represents a UL slot, and “F” 515 represents a flexible slot which could be UL or DL or special slot based on a configuration such as tdd-UL-DL-ConfigurationDedicated. Thus, for the exemplary UL-DL configuration 500 of “DDSUU”, it may be considered that the slot having Slot Index 1 is a DL slot, the flexible slot having Slot Index 2 is a DL slot, the flexible slot having Slot Index 3 is a Special “S” slot, and the slots having Slot Indices 4 and 5 are UL slots.

The user device 120 determines the indicated number of slots as the number of consecutive slots. For example, the user device 120 may determine that all the consecutive slots (for example, “6” slots) for PUSCH transmission can be used for TB processing over multi-slot. In this case, all the consecutive slots will be counted.

For example, if the PUSCH transmission enabling TB processing over multi-slot is indicated to start at a slot 510 with Slot Index “4” and ends at a slot 525 with Slot Index “9”, then these six consecutive slots (with Slot Index 4-Slot Index 9) are counted.

In some embodiments, the network device 110 may inform the user device 120: only UL slots indicated by SIB-1 UL-DL configuration (such as tdd-UL-DL-ConfigurationCommon) are determined as valid slots for transmission of the TB, and the flexible slots are determined as invalid and could not be used for transmission of the TB. In this case, the indicated number of slots associated with transmission of the TB is equivalent to a number of UL slots. That is, the user device 120 only counts the number of UL slots. As shown in FIG. 5a, the slots 510, 0.526, 525 and 527 with Slot Index 4, 5, 9 and 10 are valid for transmission of the TB. As such, even if the user device 120 missed the detection of DCI format 2_0 with SFI-RNTI, there is no UL transmission mis-alignment between the network device 110 and the user device 120.

In some embodiments, some UL slots may be reserved for high priority PUSCH transmission. For example, the slots 510, 526 and 525 with Slot Index 4, 5 and 9 may be valid UL slots, but the slot 527 with Slot Index 10 may be reserved for high priority PUSCH transmissions. In this case, the slot 527 will not be considered as valid. In some embodiments, the flexible slots in UL-DL configuration 500 as shown in FIG. 5a also can be configured as valid slots for transmission of the TB. In this case, the valid flexible slots indicated are counted in the number of slots associated with transmission of the TB.

In an example, with reference to FIG. 5a, in the case of the network device (110) counting the number consecutive slots enabled to the TB processing over multi-slot into the number of slots associated with transmission of the TB and the user device (120) indicates that the transmission is starting with Slot Index 4 according to the UL grant in DCI, then the user device (120) can derive the actual UL slots used to transmit the TB from UL-DL configuration and parameter “TotalSlotforTB”. In this case, the number of actual slots used to transmit the TB is “3” (Index 4, 5 and 9). The benefit is that even if the user device (120) missed the detection of DCI format 2_0 with SFI-RNTI, there is no the UL transmission mis-alignment between the network device (110) and the user device (120).

In the embodiments where the number of slots indicated by the network device 110 represents the number of valid slots, the user device may only count valid slots. An example process will discussed below with reference to FIG. 5b.

FIG. 5b shows a UL-DL configuration 530 indicated by SIB-1 UL-DL configuration and UE dedicated signaling according some embodiments of the present disclosure.

In this example, the UL slots indicated by SIB-1 UL-DL configuration and additional UL slots (for example, flexible slots 535 and 540 with Slot Index 3 and 8) indicated by UE dedicated UL-DL configuration are configured as valid slots for transmission of the TB. In this case, the indicated number of slots is equivalent to a total number of UL slots and indicated flexible slots. As shown in FIG. 5b, the slots 535-546 with Slot. Index 3, 4, 5, 8, 9 and 10 are valid for transmission of the TB.

The flexible slot transmission direction may also be configured by Slot Format Indication (SFI) (i.e., DCI format 2_0). In some embodiments, the network device 110 may inform the user device 120: the UL slots indicated by SIB-1 UL-DL configuration and additional UL slots (for example, flexible slots 535 and 540 with Slot Index 3 and 8 in FIG. 5b are indicated as additional UL slots by the UE dedicated signaling) indicated by SFI are determined as valid slots for transmission of the TB. In this case, the indicated number of slots associated with transmission of the TB is equivalent to a number of UL slots and valid flexible slots indicated by SFI. If the user device 120 missed detection of DCI format 2_0, the flexible slots are counted as valid slots, but will not be used for data transmission, to avoid additional cross link interference due to mis-alignment on transmission direction between the network device 110 and the user device 120.

In some other embodiments, the network device 110 may inform the user device 120: the UL slots indicated by SIB-1 UL-DL configuration and all flexible slots are determined as valid slots for transmission of the TB. Then, the user device 120 may assume all the flexible slots are valid slots for transmission of the TB. In this case, the indicated number of slots associated with transmission of the TB is equivalent to a total number of UL slots and all flexible slots indicated by SFI.

In some embodiments, the user device 120 may receive an indication of cancelling validity of certain valid slots. For example, if the user device 120 is configured with Cancellation Indication-Radio Network Temporary Identity (CI-RNTI) and detects the DCI format 2_4 with CI-RNTI, the user device 120 cancels the TB transmission according to the cancellation indication in the DCI. Thus, a valid slot may be disabled by Cancellation indication. In this way, if the TB transmission is colliding with the high priority PUSCH transmission, such as ultra-reliable and low latency communication (URLLC) service, the low priority transmission, such as TB transmission, can be cancelled by DCI scrambled CI-RNTI.

Still with reference to FIG. 2, after the plurality of valid slots are determined (230), the user device 120 transmits (240) the TB to the network device 110 in the plurality of valid slots. For example, the user device 120 may determine a plurality of resources in the plurality of valid slots and transmit the TB to the network device 110 in the valid slots using the resources.

In some embodiments, the user device 120 may determine the resource in the plurality of valid slots using the same resource pattern. As an example, the TDRA field in the UL grant of DCI may be applied to all the slots, except the first slot (or the starting slot). The slots offset of the first slot may be indicated by the field of k2 of UI, DCI. The positions of other slots positions may be determined according to the indication of the number of slots associated with transmission of the TB as mentioned above and/or other indications about valid slots and relative offset as mentioned above. The fields of Mapping type and startSymbolAndLength in the TDRA as shown above are the same for all the slots.

In some other embodiments, resource patterns for different slots may be different. Accordingly, the resource in each slot may be determined individually. The resource patterns may be indicated by the network device 110. For example, the resource pattern allocated per slot may be indicated by a configuration of PUSCH mapping type and symbol allocation. In some embodiments, the resource in the first slot may be derived from the TDRA field in the UL DCI. Alternatively, the resource in this slot can be indicated via a MAC CE, thus the TDRA field of UL DCI may be reserved for other purpose.

The resource patterns for the remaining slots may be indicated via a MAC CE. For example, for each slot, the fields k2, Mapping type and startSymbolAndLength (aka, SLIV) may be used. The value of the field k2 for a valid slot is a value relative to that for previous valid slots, and therefore bit overhead may be reduced.

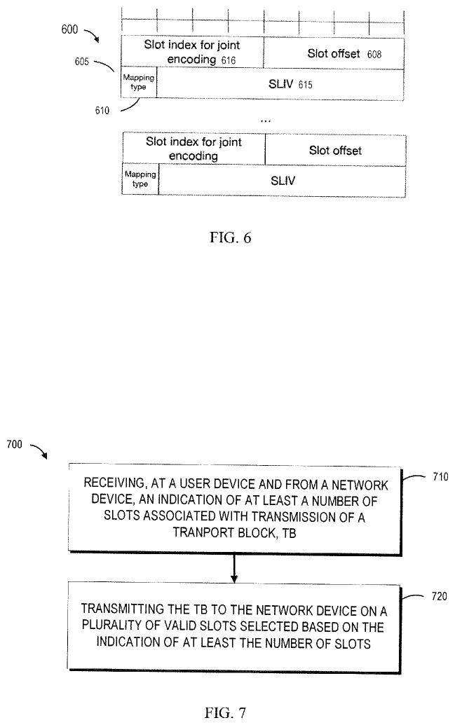

FIG. 6 shows an example MAC CE configuration 600 for the resource patterns according to some embodiments of the present disclosure.

In the MAC CE 605, for each valid slot, there are at least three fields 608, 610 and 615, including Slot offset (relative to k2 or relative to previous valid slot), Mapping type and SLIV. In this example, the slot index for joint encoding 616 (indicating the parameter “totalSlotforTB”) is also included in MAC CE 605.

FIG. 7 shows a flowchart of an example method of a user equipment (UE) transmitting transport blocks (TB) to a network device according to some example embodiments of the present disclosure. At block 710, a UE receives from a network device, an indication of at least a number of slots associated with transmission of a transport block, TB. At block 720, the UE transmits the TB to the network device on a plurality of valid slots selected based on the indication of at least the number of slots. In some example embodiments, the number of slots comprises at least one of a number of consecutive slots or a number of valid slots.

In some example embodiments, wherein receiving the indication of at least the number of slots comprises: receiving the indication of at least the number of slots via at least one of: radio resource control, RRC, signaling, a media access control, MAC, control element, CE, or downlink control information, DCI.

In some example embodiments, wherein receiving the indication of at least the number of slots comprises: receiving, from the network device, an indication of a time domain resource allocation, TDRA, table, the TDRA table containing an entry indicating a set of candidate numbers of slots; and receiving, from the network device, an indication of a candidate number of slots from the set of candidate numbers of slots as the indication of at least the number of slots.

In some example embodiments, wherein the plurality of valid slots comprise a set of valid uplink slots.

In some example embodiments, wherein the plurality of valid slots further comprise a set of valid flexible slots.

In some example embodiments, further comprising: receiving, from the network device, an indication of a valid flexible slot configuration; and determining the set of valid flexible slots based on the valid flexible slot configuration.

In some example embodiments, wherein the indication of at least the number of slots further indicates: a set of relative offset between adjacent valid slots of the plurality of valid slots, or a set of relative offset of the plurality of valid slots with respect to a starting valid slot of the plurality of valid slots.

In some example embodiments, wherein the indication is received via a media access control, MAC, control element, CE.

In some example embodiments, further comprising: receiving, from the network device, an indication of a starting valid slot of the plurality of valid slot.

In some example embodiments, wherein transmitting the TB in the plurality of valid slots comprises: determining, in the plurality of valid slots, a plurality of resources for the transmission of the TB; and transmitting, to the network device, the TBs in the plurality of valid slots using the plurality of resources.

In some example embodiments, further comprising: receiving an indication of cancelling validity of at least one of the plurality of valid slots.

In some example embodiments, wherein determining the plurality of resources in the plurality of valid slots comprises: determining, based on a resource pattern received, the plurality of resources for the plurality of valid slots.

In some example embodiments, wherein determining the plurality of resources in the plurality of valid slots comprises: determining, based on different resource patterns received, the plurality of resources for the plurality of valid slots.

In some example embodiments, receiving the indication of at least the number of slots comprises: receiving the indication of at least the number of slots and an indication of the resource patterns via one media access control, MAC, control element, CE.

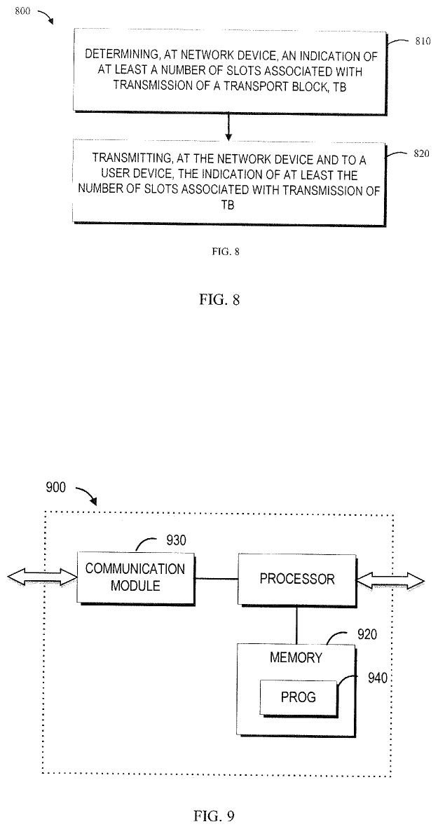

FIG. 8 shows a flowchart of an example method of a network device configuring a number of slots for a TB transmission according to some example embodiments of the present disclosure. At block 810, a network device determines an indication of at least a number of slots associated with transmission of a transport block, TB. At block 820, the network device transmits to a user device, the indication of at least the number of slots associated with transmission of the TB.

In some example embodiments, wherein the number of slots comprises at least one of a number of consecutive slots or a number of valid slots.

In some example embodiments, wherein transmitting the indication of at least the number of slots comprises: transmitting the indication of at least the number of slots via at least one of: radio resource control, RRC, signaling, a media access control, MAC, control element, CE, or downlink control information, DCI.

In some example embodiments, wherein transmitting the indication of at least the number of slots via the DCI comprises: transmitting, to the user device, an indication of a time domain resource allocation, TDRA, table, the TDRA table containing an entry indicating a set of candidate numbers of slots; and transmitting, to the user device, an indication of a candidate number of slots from the set of candidate numbers of slots as the indication of at least the number of slots.

In some example embodiments, wherein the plurality of valid slots comprise a set of valid uplink slots.

In some example embodiments, wherein the plurality of valid slots further comprise a set of valid flexible slots.

In some example embodiments, further comprising: determining an indication of a valid flexible slot configuration; and transmitting, to the user device, the valid flexible slot configuration.

In some example embodiments, wherein the indication of at least the number of slots further indicates: a set of relative offset between adjacent valid slots of the plurality of valid slots, or a set of relative offset of the plurality of valid slots with respect to a starting valid slot of the plurality of valid slots.

In some example embodiments, wherein the indication is transmitted via a media access control, MAC, control element, CE.

In some example embodiments, further comprises: transmitting, to the user device, an indication of a starting valid slot of the plurality of valid slot.

In some example embodiments, further comprising: transmitting an indication of cancelling validity of at least one of the plurality of valid slots.

In some example embodiments, further comprises: determining, a resource pattern indicating the plurality of resources for the plurality of valid slots.

In some example embodiments, further comprises: determining, different resource patterns indicating the plurality of resources for the plurality of valid slots.

In some example embodiments, wherein transmitting the indication of at least the number of slots comprises: transmitting the indication of at least the number of slots and an indication of the resource patters via one media access control, MAC, control element, CE.

FIG. 9 is a simplified block diagram of a device 900 that is suitable for implementing example embodiments of the present disclosure. The device 900 can be implemented at or as a part of the network device 110 or the user device 120 as shown in FIG. 1.

As shown, the device 900 includes a processor 910, a memory 920 coupled to the processor 910, a communication module 930 coupled to the processor 910, and a communication interface (not shown) coupled to the communication module 930. The memory 920 stores at least a program 940. The communication module 930 is for bidirectional communications, for example, via multiple antennas. The communication interface may represent any interface that is necessary for communication.

The program 940 is assumed to include program instructions that, when executed by the associated processor 910, enable the device 900 to operate in accordance with the example embodiments of the present disclosure, as discussed herein with reference to FIGS. 1-8. The example embodiments herein may be implemented by computer software executable by the processor 910 of the device 900, or by hardware, or by a combination of software and hardware. The processor 910 may be configured to implement various example embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 800. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

When the device 900 acts as the user device 120 or a part of the user device 120, the processor 910 and the communication module 930 may cooperate to implement the method 700 as described above with reference to FIG. 7. When the device 900 acts as the network device 110 or a part of the network device 110, the processor 910 and the communication module 930 may cooperate to implement the method 800 as described above with reference to FIG. 8. All operations and features as described above with reference to FIGS. 1-8 are likewise applicable to the device 900 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 700 or 800 as described above with reference to FIGS. 1-8. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

A method provided in first aspect comprises: receiving, at a user device and from a network device, an indication of at least a number of slots associated with transmission of a transport block, TB; and transmitting the TB to the network device over a plurality of valid slots selected based on the indication of at least the number of slots.

In some example embodiments of the first aspect, the number of slots comprises at least one of a number of consecutive slots or a number of valid slots.

In some example embodiments of the first aspect, receiving the indication of at least the number of slots comprises: receiving the indication of at least the number of slots via at least one of: radio resource control, RRC, signaling, a media access control, MAC, control element, CE, or downlink control information, DCI.

In some example embodiments of the first aspect, receiving the indication of at least the number of slots comprises: receiving, from the network device, an indication of a time domain resource allocation, TDRA, table, the TDRA table containing an entry indicating a set of candidate numbers of slots; and receiving, from the network device, an indication of a candidate number of slots from the set of candidate numbers of slots as the indication of at least the number of slots.

In some example embodiments of the first aspect, the plurality of valid slots comprise a set of valid uplink slots.

In some example embodiments of the first aspect, the plurality of valid slots further comprise a set of valid flexible slots.

In some example embodiments of the first aspect, further comprising: receiving, from the network device, an indication of a valid flexible slot configuration; and determining the set of valid flexible slots based on the valid flexible slot configuration.

In some example embodiments of the first aspect, the indication of at least the number of slots further indicates: a set of relative offset between adjacent valid slots of the plurality of valid slots, or a set of relative offset of the plurality of valid slots with respect to a starting valid slot of the plurality of valid slots.

In some example embodiments of the first aspect, the indication is received via a media access control, MAC, control element, CE.

In some example embodiments of the first aspect, further comprising: receiving, from the network device, an indication of a starting valid slot of the plurality of valid slot.

In some example embodiments of the first aspect, further comprising: receiving an indication of cancelling validity of at least one of the plurality of valid slots.

In some example embodiments of the first aspect, transmitting the TB in the plurality of valid slots comprises: determining, in the plurality of valid slots, a plurality of resources for the transmission of the TB; and transmitting, to the network device, the TBs in the plurality of valid slots using the plurality of resources.

In some example embodiments of the first aspect, determining the plurality of resources in the plurality of valid slots comprises: determining, based on a resource pattern received, the plurality of resources for the plurality of valid slots.

In some example embodiments of the first aspect, determining the plurality of resources in the plurality of valid slots comprises: determining, based on different resource patterns received, the plurality of resources for the plurality of valid slots.

In some example embodiments of the first aspect, receiving the indication of at least the number of slots comprises: receiving the indication of at least the number of slots and an indication of the resource patterns via one media access control, MAC, control element, CE.

A method provided in a second aspect comprises: determining, at a network device, a number of slots associated with transmission of a transport block, TB; and transmitting, at the network device and to a user device, the indication of at least the number of slots associated with transmission of the TB to enable the user device to determine a plurality of valid slots for the transmission of the TB.

In some example embodiments of the second aspect, the number of slots comprises at least one of a number of consecutive slots or a number of valid slots.

In some example embodiments of the second aspect, transmitting the indication of at least the number of slots comprises: transmitting the indication of at least the number of slots via at least one of: radio resource control, RRC, signaling, a media access control, MAC, control element, CE, or downlink control information, DCI.

In some example embodiments of the second aspect, transmitting the indication of at least the number of slots via the DCI comprises: transmitting, to the user device, an indication of a time domain resource allocation, TDRA, table, the TDRA table containing an entry indicating a set of candidate numbers of slots; and transmitting, to the user device, an indication of a candidate number of slots from the set of candidate numbers of slots as the indication of at least the number of slots.

In some example embodiments of the second aspect, the plurality of valid slots comprise a set of valid uplink slots.

In some example embodiments of the second aspect, the plurality of valid slots further comprise a set of valid flexible slots.

In some example embodiments of the second aspect, further comprising: determining an indication of a valid flexible slot configuration; and transmitting, to the user device, the valid flexible slot configuration.

In some example embodiments of the second aspect, the indication of at least the number of slots further indicates: a set of relative offset between adjacent valid slots of the plurality of valid slots, or a set of relative offset of the plurality of valid slots with respect to a starting valid slot of the plurality of valid slots.

In some example embodiments of the second aspect, the indication is transmitted via a media access control, MAC, control element, CE.

In some example embodiments of the second aspect, further comprises: transmitting, to the user device, an indication of a starting valid slot of the plurality of valid slot.

In some example embodiments of the second aspect, the method further comprises: transmitting an indication of cancelling validity of at least one of the plurality of valid slots.

In some example embodiments of the second aspect, the method further comprises: determining, a resource pattern indicating the plurality of resources for the plurality of valid slots.

In some example embodiments of the second aspect, the method further comprises: determining, different resource patterns indicating the plurality of resources for the plurality of valid slots.

In some example embodiments of the second aspect, transmitting the indication of at least the number of slots comprises: transmitting the indication of at least the number of slots and an indication of the resource patters via one media access control, MAC, control element, CE.

A user device provided in a third aspect, comprises: at least one processor; and at least one memory including computer program code; the at least one memory and the computer program code configured to, with the at least one processor, cause the user device to: receiving, at a user device and from a network device, an indication of at least a number of slots associated with transmission of a transport block, TB; and transmitting the TB to the network device over a plurality of valid slots selected based on the indication of at least the number of slots.

In some example embodiments of the third aspect, the number of slots comprises at least one of a number of consecutive slots or a number of valid slots.

In some example embodiments of the third aspect, the user device is caused to receive the indication of at least the number of slots by: receiving the indication of at least the number of slots via at least one of: radio resource control, RRC, signaling, a media access control, MAC, control element, CE, or downlink control information, DCI.

In some example embodiments of the third aspect, the user device is caused to receive the indication of at least the number of slots by: receiving, from the network device, an indication of a time domain resource allocation, TDRA, table, the TDRA table containing an entry indicating a set of candidate numbers of slots; and receiving, from the network device, an indication of a candidate number of slots from the set of candidate numbers of slots as the indication of at least the number of slots.

In some example embodiments of the third aspect, the plurality of valid slots comprise at least one of a set of valid uplink slots.

In some example embodiments of the third aspect, the plurality of valid slots further comprise a set of valid flexible slots.

In some example embodiments of the third aspect, the user device is further caused to: receiving, from the network device, an indication of a valid flexible slot configuration; and determining the set of valid flexible slots based on the valid flexible slot configuration.

In some example embodiments of the third aspect, the indication of at least the number of slots further indicates: a set of relative offset between adjacent valid slots of the plurality of valid slots, or a set of relative offset of the plurality of valid slots with respect to a starting valid slot of the plurality of valid slots.

In some example embodiments of the third aspect, the indication is received via a media access control, MAC, control element, CE.

In some example embodiments of the third aspect, the user device is further caused to: receiving, from the network device, an indication of a starting valid slot of the plurality of valid slot.

In some example embodiments of the third aspect, the user device is further caused to: receiving an indication of cancelling validity of at least one of the plurality of valid slots.

In some example embodiments of the third aspect, the user device is caused to transmit the TB in the plurality of valid slots by: determining, in the plurality of valid slots, a plurality of resources for the transmission of the TB; and transmitting, to the network device, the TBs in the plurality of valid slots using the plurality of resources.

In some example embodiments of the third aspect, the user device is caused to determine the plurality of resources in the plurality of valid slots by: determining, based on a resource pattern received, the plurality of resources for the plurality of valid slots.

In some example embodiments of the third aspect, the user device is caused to determine the plurality of resources in the plurality of valid slots by: determining, based on different resource patterns received, the plurality of resources for the plurality of valid slots.

In some example embodiments of the third aspect, the user device is caused to receive the indication of at least the number of slots by: receiving the indication of at least the number of slots and an indication of the resource patterns via one media access control, MAC, control element, CE.

A network device provided in a fourth aspect, comprises: at least one processor; and at least one memory including computer program code; the at least one memory and the computer program code configured to, with the at least one processor, cause the network device to: determining, at a network device, a number of slots associated with transmission of a transport block, TB; and transmitting, at the network device and to a user device, the indication of at least the number of slots associated with transmission of the TB to enable the user device to determine a plurality of valid slots for the transmission of the TB.

In some example embodiments of the fourth aspect, the number of slots comprises at least one of a number of consecutive slots or a number of valid slots.

In some example embodiments of the fourth aspect, the network device is caused to transmit the indication of at least the number of slots via the DCI by: transmitting the indication of at least the number of slots via at least one of: radio resource control, RRC, signaling, a media access control, MAC, control element, CE, or downlink control information, DCI.

In some example embodiments of the fourth aspect, the network device is caused to transmit the indication of at least the number of slots by: transmitting, to the user device, an indication of a time domain resource allocation, TDRA, table, the TDRA table containing an entry indicating a set of candidate numbers of slots; and transmitting, to the user device, an indication of a candidate number of slots from the set of candidate numbers of slots as the indication of at least the number of slots.

In some example embodiments of the fourth aspect, the plurality of valid slots further comprise a set of valid uplink slots.

In some example embodiments of the fourth aspect, the plurality of valid slots further comprise a set of valid flexible slots.

In some example embodiments of the fourth aspect, the network device is further caused to: determining an indication of a valid flexible slot configuration; and transmitting, to the user device, the valid flexible slot configuration.

In some example embodiments of the fourth aspect, the indication of at least the number of slots further indicates: a set of relative offset between adjacent valid slots of the plurality of valid slots, or a set of relative offset of the plurality of valid slots with respect to a starting valid slot of the plurality of valid slots.

In some example embodiments of the fourth aspect, the indication is transmitted via a media access control, MAC, control element, CE.

In some example embodiments of the fourth aspect, the network device is further caused to: transmitting, to the user device, an indication of a starting valid slot of the plurality of valid slot.

In some example embodiments of the fourth aspect, the network device is further caused to: transmitting an indication of cancelling validity of at least one of the plurality of valid slots. In some example embodiments of the fourth aspect, the network device is further caused to: determining, a resource pattern indicating the plurality of resources for the plurality of valid slots.

In some example embodiments of the fourth aspect, the network device is further caused to: determining, different resource patterns indicating the plurality of resources for the plurality of valid slots.

In some example embodiments of the fourth aspect, the network device is caused to transmit the indication of at least the number of slots by: transmitting the indication of at least the number of slots and an indication of the resource patters via one media access control, MAC, control element, CE.

An apparatus provided in a fifth aspect, comprises: means for receiving, at a user device and from a network device, an indication of at least a number of slots associated with transmission of a transport block, TB; and means for transmitting the TB to the network device over a plurality of valid slots selected based on the indication of at least the number of slots.

In some example embodiments of the fifth aspect, the number of slots comprises at least one of a number of consecutive slots or a number of valid slots.

In some example embodiments of the fifth aspect, the means for receiving an indication of at least a number of slots comprises: means for receiving the indication of at least the number of slots via at least one of: radio resource control, RRC, signaling, a media access control. MAC, control element, CE, or downlink control information, DCI.

In some example embodiments of the fifth aspect, the means for receiving an indication of at least a number of slots comprises: means for receiving, from the network device, an indication of a time domain resource allocation, TDRA, table, the TDRA table containing an entry indicating a set of candidate numbers of slots; and means for receiving, from the network device, an indication of a candidate number of slots from the set of candidate numbers of slots as the indication of at least the number of slots.

In some example embodiments of the fifth aspect, the plurality of valid slots comprise a set of valid uplink slots.

In some example embodiments of the fifth aspect, the plurality of valid slots further comprise a set of valid flexible slots.

In some example embodiments of the fifth aspect, the apparatus further comprises: means for receiving, from the network device, an indication of a valid flexible slot configuration; and means for determining the set of valid flexible slots based on the valid flexible slot configuration.

In some example embodiments of the fifth aspect, the indication of at least the number of slots further indicates: a set of relative offset between adjacent valid slots of the plurality of valid slots, or a set of relative offset of the plurality of valid slots with respect to a starting valid slot of the plurality of valid slots.

In some example embodiments of the fifth aspect, the indication is received via a media access control, MAC, control element, CE.

In some example embodiments of the fifth aspect, the apparatus further comprises: means for receiving, from the network device, an indication of a starting valid slot of the plurality of valid slot.

In some example embodiments of the fifth aspect, the apparatus further comprises: means for receiving an indication of cancelling validity of at least one of the plurality of valid slots.

In some example embodiments of the fifth aspect, the means for transmitting the TB in the plurality of valid slots comprises: means for determining, in the plurality of valid slots, a plurality of resources for the transmission of the TB; and means for transmitting, to the network device, the TBs in the plurality of valid slots using the plurality of resources.

In some example embodiments of the fifth aspect, the means for determining the plurality of resources in the plurality of valid slots comprises: means for determining, based on a resource pattern received, the plurality of resources for the plurality of valid slots.

In some example embodiments of the fifth aspect, the means for determining the plurality of resources in the plurality of valid slots comprises: determining, based on different resource patterns received, the plurality of resources for the plurality of valid slots.

In some example embodiments of the fifth aspect, means for receiving the indication of at least the number of slots comprises: means for receiving the indication of at least the number of slots and an indication of the resource patterns via one media access control, MAC, control element, CE.

An apparatus provided in a sixth aspect, comprises: means for determining, at a network device, a number of slots associated with transmission of a transport block, TB; and means for transmitting, at the network device and to a user device, the indication of at least the number of slots associated with transmission of the TB to enable the user device to determine a plurality of valid slots for the transmission of the TB.

In some example embodiments of the sixth aspect, the number of slots comprises at least one of a number of consecutive slots or a number of valid slots.

In some example embodiments of the sixth aspect, wherein means for transmitting the indication of at least the number of slots comprises: means for transmitting the indication of at least the number of slots via at least one of: radio resource control, RRC, signaling, a media access control, MAC, control element, CE, or downlink control information, DCI.

In some example embodiments of the sixth aspect, the means for transmitting the indication of at least the number of slots via the DCI comprises: means for transmitting, to the user device, an indication of a time domain resource allocation, TDRA, table, the TDRA table containing an entry indicating a set of candidate numbers of slots; and means for transmitting, to the user device, an indication of a candidate number of slots from the set of candidate numbers of slots as the indication of at least the number of slots.

In some example embodiments of the sixth aspect, the plurality of valid slots comprise a set of valid uplink slots.

In some example embodiments of the sixth aspect, the plurality of valid slots further comprise a set of valid flexible slots.

In some example embodiments of the sixth aspect, the apparatus further comprises: means for determining an indication of a valid flexible slot configuration; and means for transmitting, to the user device, the valid flexible slot configuration.

In some example embodiments of the sixth aspect, the indication of at least the number of slots further indicates: a set of relative offset between adjacent valid slots of the plurality of valid slots, or a set of relative offset of the plurality of valid slots with respect to a starting valid slot of the plurality of valid slots.

In some example embodiments of the sixth aspect, the indication is transmitted via a media access control, MAC, control element, CE.

In some example embodiments of the sixth aspect, the apparatus further comprises: means for transmitting, to the user device, an indication of a starting valid slot of the plurality of valid slot.

In some example embodiments of the sixth aspect, the apparatus further comprises: means for transmitting an indication of cancelling validity of at least one of the plurality of valid slots.

In some example embodiments of the sixth aspect, the apparatus further comprises: means for determining, a resource pattern indicating the plurality of resources for the plurality of valid slots.

In some example embodiments of the sixth aspect, the apparatus further comprises: means for determining, different resource patterns indicating the plurality of resources for the plurality of valid slots.

In some example embodiments of the sixth aspect, the means for transmitting the indication of at least the number of slots comprises: means for transmitting the indication of at least the number of slots and an indication of the resource patters via one media access control, MAC, control element, CE.

A computer readable storage medium comprising program instructions stored thereon is provided in a seventh aspect, the instructions, when executed by a processor of a device, causing the device to perform the method of the first aspect.

A computer readable storage medium comprising program instructions stored thereon is provided in an eighth aspect, the instructions, when executed by a processor of a device, causing the device to perform the method of the second aspect.

In some aspects, a baseband processor of a user device is configured to perform the method of the first aspect.

In some aspects, a baseband processor of a network device is configured to perform the method of the second aspect.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A user device, comprising
at least one processor; and
at least one memory including computer program code;
the at least one memory and the computer program code configured to, with the at least one processor, cause the user device to:
receive, from a network device, an indication of at least a number of slots associated with transmission of a transport block, TB; and
transmit the TB to the network device over a plurality of valid slots selected based on the indication of at least the number of slots.

2. The user device of claim 1, wherein the number of slots comprises at least one of a number of consecutive slots or a number of valid slots.

3. The user device of claim 1, wherein the user device is caused to receive the indication of at least the number of slots by:
receiving the indication of at least the number of slots via at least one of:
radio resource control, RRC, signaling,
a media access control, MAC, control element, CE, or
downlink control information, DCI.

4. The user device of claim 1, wherein the user device is caused to receive the indication of at least the number of slots by:
receiving, from the network device, an indication of a time domain resource allocation, TDRA, table, the TDRA table containing an entry indicating a set of candidate numbers of slots; and
receiving, from the network device, an indication of a candidate number of slots from the set of candidate numbers of slots as the indication of at least the number of slots.

5. The user device of claim 1, wherein the plurality of valid slots comprise at least one of a set of valid uplink slots.

6. The user device of claim 5 wherein the plurality of valid slots further comprise a set of valid flexible slots.

7. The user device of claim 6, wherein the user device is further caused to:
receiving, from the network device, an indication of a valid flexible slot configuration; and
determining the set of valid flexible slots based on the valid flexible slot configuration.

8. The user device of claim 1, wherein the indication of at least the number of slots further indicates:
a set of relative offset between adjacent valid slots of the plurality of valid slots, or
a set of relative offset of the plurality of valid slots with respect to a starting valid slot of the plurality of valid slots.

9. The user device of claim 8, wherein the indication is received via a media access control, MAC, control element, CE.

10. The user device of claim 1, wherein the user device is further caused to:
receiving, from the network device, an indication of a starting valid slot of the plurality of valid slot.

11. The user device of claim 1, wherein the user device is further caused to:
receiving an indication of cancelling validity of at least one of the plurality of valid slots.

12. The user device of claim 1, wherein the user device is caused to transmit the TB in the plurality of valid slots by:
determining, in the plurality of valid slots, a plurality of resources for the transmission of the TB; and
transmitting, to the network device, the TBs in the plurality of valid slots using the plurality of resources.

13. The user device of claim 12, wherein the user device is caused to determine the plurality of resources in the plurality of valid slots by:
determining, based on a resource pattern received, the plurality of resources for the plurality of valid slots.

14. The user device of claim 12, wherein the user device is caused to determine the plurality of resources in the plurality of valid slots by:
determining, based on different resource patterns received, the plurality of resources for the plurality of valid slots.

15. The user device of claim 14, wherein the user device is caused to receive the indication of at least the number of slots by:
receiving the indication of at least the number of slots and an indication of the resource patterns via one media access control, MAC, control element, CE.

16. A network device, comprising:
at least one processor; and
at least one memory including computer program code;
the at least one memory and the computer program code configured to, with the at least one processor, cause the network device to:
determine a number of slots associated with transmission of a transport block, TB; and
transmit, to a user device, an indication of at least the number of slots associated with transmission of the TB to enable the user device to determine a plurality of valid slots for the transmission of the TB.

17. The network device of claim 16, wherein the number of slots comprises at least one of a number of consecutive slots or a number of valid slots.

18. The network device of claim 16, wherein the network device is caused to transmit the indication of at least the number of slots by:
transmitting the indication of at least the number of slots via at least one of:
radio resource control, RRC, signaling,
a media access control, MAC, control element, CE, or
downlink control information, DCI.

19. The network device of claim 16, wherein the network device is caused to transmit the indication of at least the number of slots via the DCI by:
transmitting, to the user device, an indication of a time domain resource allocation, TDRA, table, the TDRA table containing an entry indicating a set of candidate numbers of slots; and
transmitting, to the user device, an indication of a candidate number of slots from the set of candidate numbers of slots as the indication of at least the number of slots.

20. The network device of claim 16, wherein the plurality of valid slots comprise a set of valid uplink slots.

21-37. (canceled)
